(19) United States
(12) Patent Application Publication
(10) Pub. No.: US 2026/0161736 A1
(43) Pub. Date: Jun. 11, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventor: Riki ETO, Tokyo (JP)

(73) Assignee: NEC Corporation, Tokyo (JP)

(21) Appl. No.: 19/178,985

(22) Filed: Apr. 15, 2025

(30) Foreign Application Priority Data
Apr. 24, 2024 (JP) 2024-070836

(51) Int. Cl. G06F 17/18

(52) U.S. Cl. CPC G06F 17/18

(57) ABSTRACT

Provided is an information processing apparatus which is capable of assigning highly accurate interior division proportion parameters. This information processing apparatus includes an acquiring section for acquiring target data, the number of a plurality of target models, and information regarding a prior distribution of a latent variable, a regression coefficient computing section for computing respective regression coefficients of the plurality of target models, a covariance computing section for computing a covariance parameter of the prior distribution of the latent variable and a covariance matrix of a posterior distribution of the latent variable, an interior division proportion parameter computing section for computing the interior division proportion parameters, and an output section for outputting the regression coefficients and the interior division proportion parameters.

### CROSS REFERENCE TO RELATED APPLICATIONS

This application is based upon and claims the benefit of priority from Japanese Patent Application No. 2024-070836 filed on Apr. 24, 2024, the disclosure of which is incorporated herein in its entirety by reference.

### TECHNICAL FIELD

The present disclosure relates to an information processing apparatus, an information processing method, and a recording medium.

### BACKGROUND ART

Techniques regarding linear parameter-varying (LPV) models are known.

For example, Patent Literature 1 discloses a method of describing a plant with use of an LPV model to form a controller for controlling the plant. In the method disclosed in Patent Literature 1, a v-gap is calculated for each of the candidates for a plurality of scheduling parameters, and scheduling parameter candidates are selected for each of the candidates in descending order of the difference between the v-gaps.

### CITATION LIST

### Patent Literature

### [Patent Literature 1]

Japanese Patent Application Publication Tokukai No. 2012-113676

### SUMMARY OF INVENTION

### Technical Problem

With regard to LVP models, it is preferable to assign a highly accurate scheduling parameter (hereinafter, also referred to as an “interior division proportion parameter”). However, the method disclosed in Patent Literature 1 has a problem with this point.

The present disclosure has been made in view of the above problem, and an example object thereof is to provide a technique which makes it possible to assign highly accurate interior division proportion parameters.

### Solution to Problem

An information processing apparatus in accordance with an example aspect of the present disclosure includes at least one processor, and the at least one processor carries out: an acquiring process of acquiring target data, the number of a plurality of target models, and information regarding a prior distribution of a latent variable; a regression coefficient computing process of computing respective regression coefficients of the plurality of target models with reference to the target data and interior division proportion parameters which define interior division proportions of the plurality of target models; a covariance computing process of computing a covariance parameter of the prior distribution of the latent variable and a covariance matrix of a posterior distribution of the latent variable, with reference to the target data, the interior division proportion parameters, the respective regression coefficients, and the information regarding the prior distribution of the latent variable; an interior division proportion parameter computing process of computing the interior division proportion parameters with reference to the target data, the respective regression coefficients, and the covariance matrix of the posterior distribution of the latent variable; and an outputting process of outputting the respective regression coefficients and the interior division proportion parameters computed by the interior division proportion parameter computing process.

An information processing apparatus in accordance with an example aspect of the present disclosure carries out: an acquiring process of acquiring inferencing data; a predicting process of deriving a plurality of prediction results by applying, to the inferencing data, respective regression coefficients of a plurality of target models; and an outputting process of outputting the plurality of prediction results derived by the predicting process, and the respective regression coefficients of the plurality of target models are trained by a training process which includes: a regression coefficient computing process of computing the respective regression coefficients of the plurality of target models with reference to training data and interior division proportion parameters which define interior division proportions of the plurality of target models; a covariance computing process of computing a covariance parameter of a prior distribution of a latent variable and a covariance matrix of a posterior distribution of the latent variable, with reference to the training data, the interior division proportion parameters, the respective regression coefficients computed by the regression coefficient computing process, and information regarding the prior distribution of the latent variable; and an interior division proportion parameter computing process of computing the interior division proportion parameters with reference to the training data, the respective regression coefficients computed by the regression coefficient computing process, and the covariance matrix of the posterior distribution of the latent variable.

An information processing method in accordance with an example aspect of the present disclosure includes: at least one processor acquiring target data, the number of a plurality of target models, and information regarding a prior distribution of a latent variable; the at least one processor computing respective regression coefficients of the plurality of target models with reference to the target data and interior division proportion parameters which define interior division proportions of the plurality of target models; the at least one processor computing a covariance parameter of the prior distribution of the latent variable and a covariance matrix of a posterior distribution of the latent variable with reference to the target data, the interior division proportion parameters, the respective regression coefficients, and the information regarding the prior distribution of the latent variable; the at least one processor computing the interior division proportion parameters with reference to the target data, the respective regression coefficients, and the covariance matrix of the posterior distribution of the latent variable; and the at least one processor outputting the respective regression coefficients and the interior division proportion parameters computed by the computing of the interior division proportion parameters.

The information processing apparatuses in accordance with the example embodiments of the present invention may be provided by a computer. In that case, a program for causing a computer to operate as the sections (software elements) of the information processing apparatuses and thereby providing the information processing apparatuses via the computer is within the scope of the present invention.

### Advantageous Effects of Invention

An example aspect of the present disclosure provides an example advantage of making it possible to assign highly accurate interior division proportion parameters.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing apparatus in accordance with the present disclosure.

FIG. 4 is a flowchart illustrating a flow of an information processing method in accordance with the present disclosure.

FIG. 5 is a block diagram illustrating a configuration of an information processing apparatus in accordance with the present disclosure.

FIG. 6 is a schematic view of outputs of respective vertex models in an LPV model in accordance with the present disclosure and interior division proportion parameters by which the respective outputs are multiplied.

FIG. 7 is a diagram illustrating an example flow of processes in the information processing apparatus in accordance with the present disclosure.

FIG. 8 is an example of graphs displayed by an output section in accordance with the present disclosure via an input-output section.

FIG. 9 is another example of graphs displayed by an output section in accordance with the present disclosure via an input-output section.

FIG. 10 is a block diagram illustrating a configuration of an information processing apparatus in accordance with the present disclosure.

FIG. 11 is a block diagram illustrating a configuration of a computer which functions as the information processing apparatuses in accordance with the present disclosure.

### EXAMPLE EMBODIMENTS

The following description will discuss example embodiments of the present invention. However, the present invention is not limited to the example embodiments described below, but can be altered by a skilled person in the art within the scope of the claims. For example, any embodiment derived by appropriately combining technical means adopted in differing example embodiments described below can be within the scope of the present invention. Further, any embodiment derived by appropriately omitting one or more of the technical means adopted in differing example embodiments described below can be within the scope of the present invention. Furthermore, the advantage mentioned in each of the example embodiments described below is an example advantage expected in that example embodiment, and does not define the extension of the present invention. That is, any embodiment which does not provide any of the example advantages mentioned in the example embodiments described below can also be within the scope of the present invention.

### First Example Embodiment

The following description will discuss a first example embodiment, which is an example embodiment of the present invention, in detail with reference to the drawings. The present example embodiment is basic to each of the example embodiments which will be described later. It should be noted that the applicability of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle.

### (Configuration of Information Processing Apparatus 1)

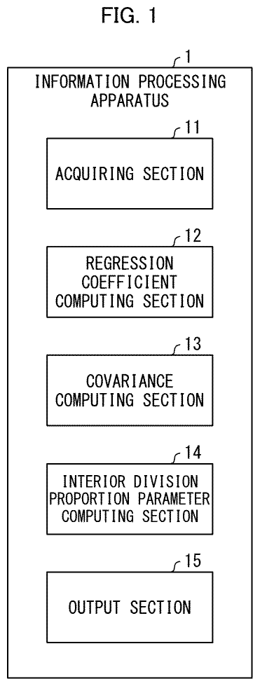

The configuration of an information processing apparatus 1 is described here with reference to FIG. 1. FIG. 1 is a block diagram illustrating the configuration of the information processing apparatus 1. The information processing apparatus 1 includes an acquiring section 11, a regression coefficient computing section 12, a covariance computing section 13, an interior division proportion parameter computing section 14, and an output section 15, as illustrated in FIG. 1. In the present example embodiment, the acquiring section 11, the regression coefficient computing section 12, the covariance computing section 13, the interior division proportion parameter computing section 14, and the output section 15 implement the acquiring means, the regression coefficient computing means, the covariance computing means, the interior division proportion parameter computing means, and the output means, respectively.

### (Acquiring Section 11)

The acquiring section 11 acquires target data, the number of a plurality of target models, and information regarding a prior distribution of a latent variable. The acquiring section 11 supplies the regression coefficient computing section 12, the covariance computing section 13, and the interior division proportion parameter computing section 14 with the acquired target data. The acquiring section 11 supplies the regression coefficient computing section 12 with the acquired number of the plurality of target models. Further, the acquiring section 11 supplies the covariance computing section 13 with the acquired information regarding the prior distribution of the latent variable.

The information regarding the prior distribution of the latent variable includes a covariance matrix of the prior distribution of the latent variable. Further, the information regarding the prior distribution of the latent variable may include a covariance parameter (which can hereinafter be referred to as a “covariance parameter of the model likelihood”) of the prior distribution of the latent variable. In the information processing apparatus 1 in accordance with the present example embodiment, an interior division proportion parameter is calculated as an expectation of the latent variable.

### (Regression Coefficient Computing Section 12)

The regression coefficient computing section 12 computes respective regression coefficients of the plurality of target models with reference to the target data and interior division proportion parameters which define the interior division proportions of the plurality of target models. The regression coefficient computing section 12 supplies the covariance computing section 13, the interior division proportion parameter computing section 14, and the output section 15 with the computed regression coefficients.

### (Covariance Computing Section 13)

The covariance computing section 13 computes a covariance parameter of the prior distribution of the latent variable and a covariance matrix of a posterior distribution of the latent variable, with reference to the target data, the interior division proportion parameters, the regression coefficients, and the information regarding the prior distribution of the latent variable. The covariance computing section 13 supplies the interior division proportion parameter computing section 14 with the computed covariance parameter of the prior distribution of the latent variable and the computed covariance matrix of the posterior distribution of the latent variable.

### (Interior Division Proportion Parameter Computing Section 14)

The interior division proportion parameter computing section 14 computes the interior division proportion parameters with reference to the target data, the regression coefficients, and the covariance matrix of the posterior distribution of the latent variable. As an example, the interior division proportion parameter computing section 14 calculates the interior division proportion parameters as the expectation of the latent variable. The interior division proportion parameter computing section 14 supplies the output section 15 with the computed interior division proportion parameters.

### (Output Section 15)

The output section 15 outputs the regression coefficients and the interior division proportion parameters computed by the interior division proportion parameter computing section 14. For example, the regression coefficients and the interior division proportion parameters outputted by the output section 15 are stored in a storage section (not illustrated) and/or provided to an apparatus external to the information processing apparatus 1 via an input-output section (not illustrated).

### Example Advantage of Information Processing Apparatus 1

As above, the information processing apparatus 1 includes an acquiring section 11 for acquiring target data, the number of a plurality of target models, and information regarding a prior distribution of a latent variable, a regression coefficient computing section 12 for computing respective regression coefficients of the plurality of target models with reference to the target data and interior division proportion parameters which define the interior division proportions of the plurality of target models, a covariance computing section 13 for computing a covariance parameter of the prior distribution of the latent variable and a covariance matrix of a posterior distribution of the latent variable with reference to the target data, the interior division proportion parameters, the regression coefficients, and the information regarding the prior distribution of the latent variable, an interior division proportion parameter computing section 14 for computing the interior division proportion parameters with reference to the target data, the regression coefficients, and the covariance matrix of the posterior distribution of the latent variable, and an output section 15 for outputting the regression coefficients and the interior division proportion parameters computed by the interior division proportion parameter computing section 14. Thus, the information processing apparatus 1 provides an example advantage of making it possible to assign highly accurate interior division proportion parameters.

### (Flow of Information Processing Method S1)

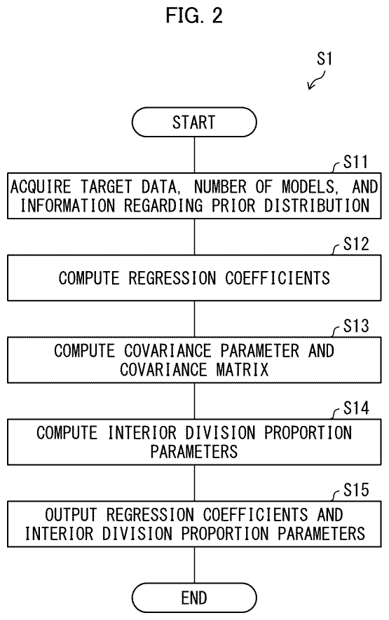

The flow of information processing method S1 is described here with reference to FIG. 2. FIG. 2 is a flowchart illustrating the flow of the information processing method S1. The information processing method S1 includes an acquiring process S11, a regression coefficient computing process S12, a covariance computing process S13, an interior division proportion parameter computing process S14, and an outputting process S15, as illustrated in FIG. 2.

### (Acquiring Process S11)

In the acquiring process S11, the acquiring section 11 acquires target data, the number of a plurality of target models, and information regarding a prior distribution of a latent variable. The acquiring section 11 supplies the regression coefficient computing section 12, the covariance computing section 13, and the interior division proportion parameter computing section 14 with the acquired target data. The acquiring section 11 supplies the regression coefficient computing section 12 with the acquired number of the plurality of target models. Further, the acquiring section 11 supplies the covariance computing section 13 with the acquired information regarding the prior distribution of the latent variable.

### (Regression Coefficient Computing Process S12)

In the regression coefficient computing process S12, the regression coefficient computing section 12 computes respective regression coefficients of the plurality of target models with reference to the target data and interior division proportion parameters which define the interior division proportions of the plurality of target models. The regression coefficient computing section 12 supplies the covariance computing section 13, the interior division proportion parameter computing section 14, and the output section 15 with the computed regression coefficients.

### (Covariance Computing Process S13)

In the covariance computing process S13, the covariance computing section 13 computes a covariance parameter of the prior distribution of the latent variable and a covariance matrix of a posterior distribution of the latent variable, with reference to the target data, the interior division proportion parameters, the regression coefficients, and the information regarding the prior distribution of the latent variable. The covariance computing section 13 supplies the interior division proportion parameter computing section 14 with the computed covariance parameter of the prior distribution of the latent variable and the computed covariance matrix of the posterior distribution of the latent variable.

### (Interior Division Proportion Parameter Computing Process S14)

In the interior division proportion parameter computing process S14, the interior division proportion parameter computing section 14 computes interior division proportion parameters with reference to the target data, the regression coefficients, and the covariance matrix of the posterior distribution of the latent variable. The interior division proportion parameter computing section 14 supplies the output section 15 with the computed interior division proportion parameters.

### (Outputting Process S15)

In the outputting process S15, the output section 15 outputs the regression coefficients and the interior division proportion parameters computed in the interior division proportion parameter computing process S14.

### Example Advantage of Information Processing Method S1

As above, the information processing method S1 includes an acquiring process S11 of the acquiring section 11 acquiring target data, the number of a plurality of target models, and information regarding a prior distribution of a latent variable, a regression coefficient computing process S12 of the regression coefficient computing section 12 computing respective regression coefficients of the plurality of target models with reference to the target data and interior division proportion parameters which define the interior division proportions of the plurality of target models, a covariance computing process S13 of the covariance computing section 13 computing a covariance parameter of the prior distribution of the latent variable and a covariance matrix of a posterior distribution of the latent variable with reference to the target data, the interior division proportion parameters, the regression coefficients, and the information regarding the prior distribution of the latent variable, an interior division proportion parameter computing process S14 of the interior division proportion parameter computing section 14 computing the interior division proportion parameters with reference to the target data, the regression coefficients, and the covariance matrix of the posterior distribution of the latent variable, and an outputting process S15 of the output section 15 outputting the regression coefficients and the interior division proportion parameters computed in the interior division proportion parameter computing process S14. Thus, the information processing method S1 provides an example advantage similar to that provided by the information processing apparatus 1 above.

### (Configuration of Information Processing Apparatus 2)

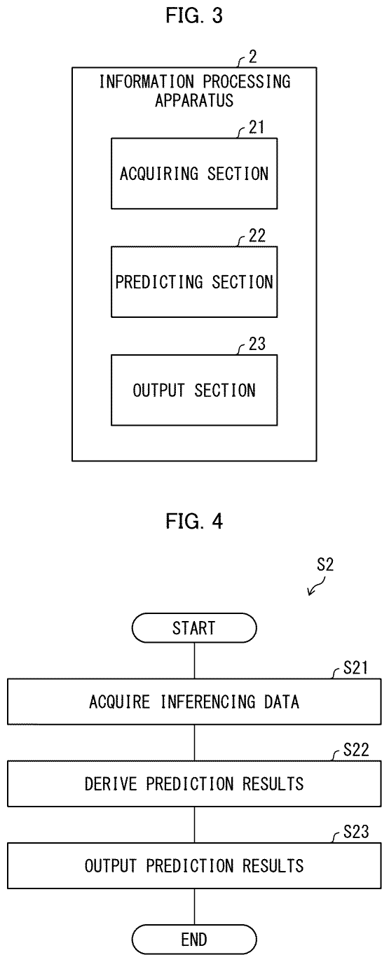

The configuration of an information processing apparatus 2 is described here with reference to FIG. 3. FIG. 3 is a block diagram illustrating the configuration of the information processing apparatus 2. The information processing apparatus 2 includes an acquiring section 21, a predicting section 22, and an output section 23, as illustrated in FIG. 3. In the present example embodiment, the acquiring section 21, the predicting section 22, and the output section 23 implement the acquiring means, the predicting means, and the output means, respectively.

The acquiring section 21 acquires inferencing data. The acquiring section 21 supplies the predicting section 22 with the acquired inferencing data.

The predicting section 22 derives a plurality of prediction results by applying, to the inferencing data, respective regression coefficients of a plurality of target models. The predicting section 22 supplies the output section 23 with the prediction results.

The output section 23 outputs the prediction results derived by the predicting section 22.

The respective regression coefficients of a plurality of target models are trained by a training process which includes a regression coefficient computing process of computing respective regression coefficients of a plurality of target models with reference to training data and interior division proportion parameters which define the interior division proportions of a plurality of target models, a covariance computing process of computing a covariance parameter of a prior distribution of a latent variable and a covariance matrix of a posterior distribution of the latent variable with reference to the training data, the interior division proportion parameters, the regression coefficients computed by the regression coefficient computing process, and information regarding the prior distribution of the latent variable, and an interior division proportion parameter computing process of computing the interior division proportion parameters with reference to the training data, the regression coefficients computed by the regression coefficient computing process, and the covariance matrix of the posterior distribution of the latent variable. As an example, the regression coefficients are calculated by the information processing apparatus 1 in accordance with the present example embodiment.

### Example Advantage of Information Processing Apparatus 2

As above, the information processing apparatus 2 includes an acquiring section 21 for acquiring inferencing data, a predicting section 22 for deriving a plurality of prediction results by applying, to the inferencing data, respective regression coefficients of a plurality of target models, and an output section 23 for outputting the prediction results derived by the predicting section 22. The respective regression coefficients of a plurality of target models are trained by a training process which includes a regression coefficient computing process of computing respective regression coefficients of a plurality of target models with reference to training data and interior division proportion parameters which define the interior division proportions of a plurality of target models, a covariance computing process of computing a covariance parameter of a prior distribution of a latent variable and a covariance matrix of a posterior distribution of the latent variable with reference to the training data, the interior division proportion parameters, the regression coefficients computed by the regression coefficient computing process, and information regarding the prior distribution of the latent variable, and an interior division proportion parameter computing process of computing the interior division proportion parameters with reference to the training data, the regression coefficients computed by the regression coefficient computing process, and the covariance matrix of the posterior distribution of the latent variable. Thus, the information processing apparatus 2 provides an example advantage similar to that provided by the information processing apparatus 1 above.

### (Flow of Information Processing Method S2)

The flow of an information processing method S2 is described here with reference to FIG. 4. FIG. 4 is a flowchart illustrating the flow of the information processing method S2. The information processing method S2 includes an acquiring process S21, a predicting process S22, and an outputting process S23, as illustrated in FIG. 4.

### (Acquiring Process S21)

In the acquiring process S21, the acquiring section 21 acquires inferencing data. The acquiring section 21 supplies the predicting section 22 with the acquired inferencing data.

### (Predicting Process S22)

In the predicting process S22, the predicting section 22 derives a plurality of prediction results by applying, to the inferencing data, respective regression coefficients of a plurality of target models. The predicting section 22 supplies the output section 23 with the prediction results.

### (Outputting Process S23)

In the outputting process S23, the output section 23 outputs the prediction results derived by the predicting section 22.

The respective regression coefficients of a plurality of target models are trained by a training process which includes a regression coefficient computing process of computing respective regression coefficients of a plurality of target models with reference to training data and interior division proportion parameters which define the interior division proportions of a plurality of target models, a covariance computing process of computing a covariance parameter of a prior distribution of a latent variable and a covariance matrix of a posterior distribution of the latent variable with reference to the training data, the interior division proportion parameters, the regression coefficients computed by the regression coefficient computing process, and information regarding the prior distribution of the latent variable, and an interior division proportion parameter computing process of computing the interior division proportion parameters with reference to the training data, the regression coefficients computed by the regression coefficient computing process, and the covariance matrix of the posterior distribution of the latent variable. As an example, the regression coefficients are calculated by the information processing method S1 in accordance with the present example embodiment.

### Example Advantage of Information Processing Method S2

As above, the information processing method S2 includes an acquiring process S21 of the acquiring section 21 acquiring inferencing data, a predicting process S22 of the predicting section 22 deriving a plurality of prediction results by applying, to the inferencing data, respective regression coefficients of a plurality of target models, and an outputting process S23 of the output section 23 outputting the prediction results derived by the predicting section 22. The respective regression coefficients of a plurality of target models are trained by a training process which includes a regression coefficient computing process of computing respective regression coefficients of a plurality of target models with reference to training data and interior division proportion parameters which define the interior division proportions of a plurality of target models, a covariance computing process of computing a covariance parameter of a prior distribution of a latent variable and a covariance matrix of a posterior distribution of the latent variable with reference to the training data, the interior division proportion parameters, the regression coefficients computed by the regression coefficient computing process, and information regarding the prior distribution of the latent variable, and an interior division proportion parameter computing process of computing the interior division proportion parameters with reference to the training data, the regression coefficients computed by the regression coefficient computing process, and the covariance matrix of the posterior distribution of the latent variable. Thus, the information processing method S2 provides an example advantage similar to that provided by the information processing apparatus 1 above.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicability of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle.

Here is the description of the positioning of the algorithm of the processing performed by an information processing apparatus 1A in accordance with the present example embodiment. The inventor of the present invention pursues the study of a linear parameter-varying model (LPV model) as the modeling of a varying system. In this LPV model, as an example, an inner state quantity (inner state variable) xₖ and an outputted state quantity (outputted state variable) yₖ are updated and calculated from the following Expression (1A) and Expression (1B).

$${x}_{k + 1} = {\sum }_{i = 1}^{m} {μ}_{k}^{( i )} ( {A}^{( i )} {x}_{k} + {B}^{( i )} {u}_{k} ) \qquad ( 1 A )$$

$${y}_{k} = {Cx}_{k} + {Du}_{k} \qquad ( 1 B )$$

In the above expressions, A⁽ⁱ⁾ and B⁽ⁱ⁾ are matrices that express state-space models (also referred to as vertex models) that are discriminated from each other by an index i and μ⁽ⁱ⁾ₖ is a parameter which defines the interior division proportion (weight) of each model. The term μ⁽ⁱ⁾ₖ is referred to as an interior division proportion parameter, referred to as a weight parameter, or referred to as a scheduling parameter. Further, in the above LPV model, uₖ is, for example, an inputted quantity (inputted variable) and C and D are outputted matrices to be operated on xₖ and uₖ, respectively. The index k is an index assigned to each state variable, and is, for example, a time.

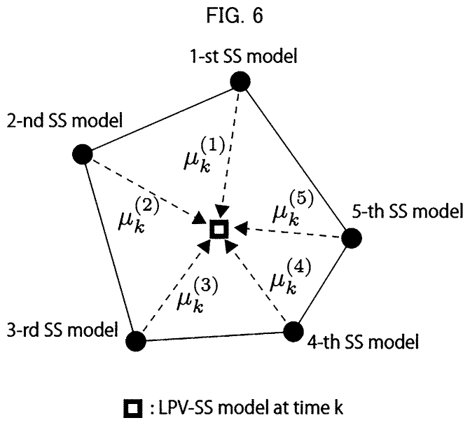

FIG. 6 is a schematic view of outputs of respective vertex models (the 1-st SS model to the 5-th SS model in FIG. 6) in the above LPV model and interior division proportion parameters μ⁽ⁱ⁾ₖ by which the respective outputs are multiplied. As illustrated in FIG. 6, the respective outputs of the plurality of vertex models at the k-th step:

$$( {A}^{( i )} {x}_{k} + {B}^{( i )} {u}_{k} ) \qquad ( i = 1 to 5 )$$

are each multiplied by the corresponding interior division proportion parameter μ⁽ⁱ⁾ₖ (i=1 to 5), so that xₖ₊₁ at the (k+1)-th step is computed.

Although such an LPV model has an aspect of being suitable as modeling of a varying system, there is a problem of being difficult to apply the LPV model to systems in which the value of the interior division proportion parameter μ⁽ⁱ⁾ₖ is not clear.

The inventor of the present invention has obtained the following finding:
treating the above interior division proportion parameter μ⁽ⁱ⁾ₖ as (the posterior probability of) a latent variable zₖ,
applying a latent variable model training method used in machine learning, and
calculating the interior division proportion parameter μ⁽ⁱ⁾ₖ as the expectation of the latent variable zₖ makes it possible to achieve the training of the LPV model even if the interior division proportion parameter is unknown. More specifically, the inventor of the present invention has conceived of rewriting a latent linear parameter-varying model (L2PV model) defined by following Expression (2A) to Expression (2C) by introducing the interior division proportion parameter μ⁽ⁱ⁾ₖ as the latent variable:

$${x}_{k + 1} = {\sum }_{i = 1}^{m} {μ}_{k}^{( i )} ( {A}^{( i )} {x}_{k} + {B}^{( i )} {u}_{k} ) + {w}_{k} , \qquad ( 2 A )$$

$${y}_{k} = {Cx}_{k} + {Du}_{k} \qquad ( 2 B )$$

$$0 \leq {μ}_{k}^{( i )} \leq , {\sum }_{i = 1}^{m} {μ}_{k}^{( i )} = 1 , \qquad ( 2 C )$$

in a regression model form (L2PV regression model) defined by the following Expression (3A) to Expression (3E):

$${\tilde{y}}_{k} = {\sum }_{i = 1}^{m} {μ}_{k}^{( i )} {W}^{( i )} {\tilde{x}}_{k} + {e}_{k} \qquad ( 3 A )$$

$$where ,$$

$$\{ \begin{matrix}{\tilde{y}}_{k} := {y}_{k + 1} ∈ & ( 3 B ) \\ {\tilde{x}}_{k} := [ \begin{matrix}{x}_{k} \\ {u}_{k}\end{matrix} ] ∈ {ℝ}^{l} & ( 3 C ) \\ {W}^{( i )} := [ \begin{matrix}{CA}^{( i )} & {CB}^{( i )} ]\end{matrix} & ( 3 D ) \\ D = 0 & ( 3 E )\end{matrix}$$

thereby training the interior division proportion parameter μ⁽ⁱ⁾ₖ.

The processes carried out by the information processing apparatus 1A described below are based on the above formulation and on the unique point of view of the inventor.

### (Configuration of Information Processing Apparatus 1A)

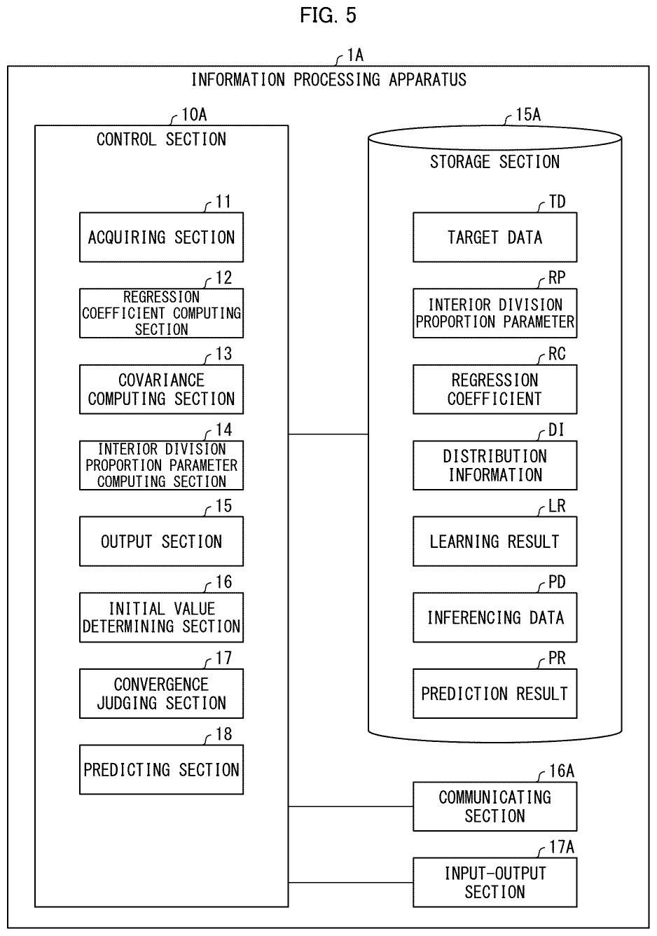

The configuration of the information processing apparatus 1A is described here with reference to FIG. 5. FIG. 5 is a block diagram illustrating the configuration of the information processing apparatus 1A. The information processing apparatus 1A includes a control section 10A, a storage section 15A, a communicating section 16A, and an input-output section 17A, as illustrated in FIG. 5.

### (Storage Section 15A)

First of all, various kinds of data (information) to be stored in the storage section 15A are described. In the storage section 15A, data referred to by the control section 10A is stored. Examples of the storage section 15A include, but are not limited to, flash memories, hard disk drives (HDDs), solid state drives (SSDs), and a combination thereof.

Examples of data to be stored in the storage section 15A include, but are not limited to, target data TD, interior division proportion parameters RP, regression coefficients RC, distribution information DI, a learning result LR, inferencing data PD, and a prediction result PR, as illustrated in FIG. 5.

The target data TD is used for a training process carried out in the information processing apparatus 1A. The target data TD is represented by the following Expression (4) as a set of a state variable (˜xₖ) and a state variable (˜yₖ). Herein, the state variables xₖ, ˜xₖ, yₖ, and ˜yₖ can be referred to as features. Further, the state variables xₖ and ˜xₖ can be referred to as explanatory variables, and the state variables yₖ and ˜yₖ can be referred to as objective variables. In a case where the objective variable is to be derived, the objective variable can be referred to as a predicted value. These specific designations do not limit the contents described herein.

$${\{ {\tilde{x}}_{k} , {\tilde{y}}_{k} \}}_{k = 1}^{N} \qquad ( 4 )$$

The interior division proportion parameters RP define relative weights of a plurality of state-space models in an LPV model, and can also be referred to as scheduling parameters. The interior division proportion parameters RP are referred to as weight parameters RP and referred to as scheduling parameters RP. As an example, the interior division proportion parameters RP are given by following Expression (5) so as to correspond to m respective models (model 1 to model m).

$${\{ {μ}_{k} \}}_{k = 1}^{N} \qquad ( 5 )$$

In the above expression, k is an index similar to the index assigned to each state variable above, and N denotes the dimension of each state variable (the number of samples of each state variable). Further, in the above expression, the index (i) regarding the models is not explicitly indicated. This may be interpreted as expressing the interior division proportion parameters RP as an interior division proportion parameter vector consisting of components which correspond to models 1 to m regarding each k:

$${μ}_{k} = ( {μ}_{k}^{( 1 )} , {μ}_{k}^{( 2 )} , … , {μ}_{k}^{( m )} )$$

In this manner, the interior division proportion parameters RP can be expressed as the interior division proportion parameter vector, or may be expressed as an interior division proportion parameter matrix.

The interior division proportion parameter μₖ^{(j)} regarding a certain model j can also be expressed as being a component of an N-dimension vector having respective components which correspond to N-dimension target data xₖ (k=1 to N). More specifically, the j-th interior division proportion parameter μₖ^{(j)} is a component of the N-dimension vector having respective components (μ₁^{(j)}, μ₂^{(j)}, . . . , μ_{N}^{(j)}) which correspond to the N-dimension target data xₖ (k=1 to N) of the N dimension.

The regression coefficients RC are coefficients in the L2PV regression model. The regression coefficients RC are represented by the following Expression (6).

$$W = [ {W}^{( 1 )} , … , {W}^{( m )} ] \qquad ( 6 )$$

The distribution information DI includes a covariance matrix Φ of a prior distribution of a latent variable, a covariance parameter η of the prior distribution of the latent variable, and a covariance parameter Ψ of a posterior distribution of the latent variable.

The prior distribution p(zₖ) of the latent variable zₖ is represented by the following Expression (7).

$$p ( {z}_{k} ) = ( {z}_{k} \vert \frac{1}{m} {1}_{m , 1} , Φ ) \qquad ( 7 )$$

In other words, the covariance parameter η of the prior distribution of the latent variable zₖ is the covariance parameter η of the model likelihood p(˜yₖ|zₖ, ˜xₖ, W, η) represented by the following Expression (8).

$$p ( {\tilde{y}}_{k} \vert {z}_{k} , {\tilde{x}}_{k} , W , η ) = ( {\tilde{y}}_{k} \vert {\sum }_{i = 1}^{m} {z}_{k}^{( i )} {W}^{( i )} {\tilde{x}}_{k} , {η}^{- 1} {I}_{r} ) \qquad ( 8 )$$

The posterior distribution p(zₖ|˜yₖ, ˜xₖ, W, η) of the latent variable zₖ is represented by the following Expression (9).

$$p ( {z}_{k} \vert {\tilde{y}}_{k} , {\tilde{x}}_{k} , W , η ) = ( {z}_{k} \vert {μ}_{k} , {Ψ}_{k} ) \qquad ( 9 )$$

It should be noted that the letter N in a calligraphy font in the right side of the above expression represents a normal distribution. However, this does not necessarily mean that an example of the distribution in the present example embodiment is limited to a normal distribution. As an example, the Dirichlet distribution may be used as the posterior distribution of the latent variable zₖ.

As described later, in the process carried out in the information processing apparatus 1A, the posterior distribution p(zₖ|yₖ,˜xₖ, TW, η) of the latent variable zₖ is expressed under a constraint condition (limiting condition) of the following Expression (10).

$$0 \leq {μ}_{k}^{( i )} \leq 1 , {\sum }_{i = 1}^{m} {μ}_{k}^{( i )} = 1 \qquad ( 10 )$$

Thus, even in a case where a normal distribution is used as the posterior distribution of the latent variable zₖ, it is possible to perform a suitable computation.

The learning result LR is data outputted by the output section 15, which will be described later. The learning result LR includes the interior division proportion parameters RP computed and the regression coefficients RC computed.

The inferencing data PD is an inner state quantity to be inputted to the L2PV regression model. The L2PV regression model receives the inferencing data PD as an input and carries out prediction by applying the computed regression coefficients RC to the plurality of respective target models.

The prediction result PR is the result of prediction carried out by the L2PV regression model. An example of the prediction result PR will be described later.

### (Communicating Section 16A)

The communicating section 16A is an interface through which data is transmitted and received via a network. Examples of the communicating section 16A include, but are not limited to, communication chips compliant with various communication standards such as Ethernet®, Wireless Fidelity (Wi-Fi®), and radio communication standards for mobile data communication networks, and USB-compliant connectors.

### (Input-Output Section 17A)

The input-output section 17A is an interface through which data input is accepted and data is outputted. Examples of the input-output section 17A include, but are not limited to, a microphone, a camera, eye-controlled input equipment, a keyboard, a touch pad, a speaker, and a liquid crystal display.

### (Control Section 10A)

The control section 10A controls the components of the information processing apparatus 1A. Further, the control section 10A includes an acquiring section 11, a regression coefficient computing section 12, a covariance computing section 13, an interior division proportion parameter computing section 14, an output section 15, an initial value determining section 16, a convergence judging section 17, and a predicting section 18, as illustrated in FIG. 5. In the present example embodiment, the acquiring section 11, the regression coefficient computing section 12, the covariance computing section 13, the interior division proportion parameter computing section 14, the output section 15, the initial value determining section 16, the convergence judging section 17, and the predicting section 18 function as the acquiring means, the regression coefficient computing means, the covariance computing means, the interior division proportion parameter computing means, the output means, the initial value determining means, the convergence judging means, and the predicting means, respectively. Specific examples of the processes carried out by the sections will be described later with reference to another drawing.

The acquiring section 11 acquires data via the communicating section 16A or the input-output section 17A. Examples of the data acquired by the acquiring section 11 include target data TD, the number of a plurality of target models, and information regarding a prior distribution of a latent variable zₖ. Another example of the data acquired by the acquiring section 11 is inferencing data PD. The acquiring section 11 stores the acquired data in the storage section 15A.

The regression coefficient computing section 12 computes respective regression coefficients RC of the plurality of target models with reference to the target data TD and interior division proportion parameters RP which define the interior division proportions of the plurality of target models. As an example, the interior division proportion parameters RP referred to by the regression coefficient computing section 12 are initial values of the interior division proportion parameters RP determined by the initial value determining section 16, which will be described later. As another example, the interior division proportion parameters RP referred to by the regression coefficient computing section 12 are the interior division proportion parameters RP computed by the interior division proportion parameter computing section 14, which will be described later. The regression coefficient computing section 12 stores the computed regression coefficients RC in the storage section 15A.

The covariance computing section 13 computes a covariance parameter η of the prior distribution of the latent variable zₖ and a covariance matrix Ψ of a posterior distribution of the latent variable zₖ with reference to the target data TD, the interior division proportion parameters RP, the regression coefficients RC, and the covariance matrix Φ of the prior distribution of the latent variable zₖ. The covariance computing section 13 stores, in the storage section 15A, the computed covariance parameter η of the prior distribution of the latent variable zₖ and the computed covariance matrix T of the posterior distribution of the latent variable zₖ, which are distribution information DI.

The interior division proportion parameter computing section 14 computes interior division proportion parameters RP with reference to the target data TD, the regression coefficients RC, and the covariance matrix T of the posterior distribution of the latent variable zₖ. The interior division proportion parameter computing section 14 stores the computed interior division proportion parameters RP in the storage section 15A.

The output section 15 outputs the regression coefficients RC, the interior division proportion parameters RP (learning result LR) computed by the interior division proportion parameter computing section 14. As an example, the output section 15 outputs, to the input-output section 17A, an image which contains the regression coefficients RC and the interior division proportion parameters RP computed by the interior division proportion parameter computing section 14. As another example, the output section 15 outputs the regression coefficients RC and the interior division proportion parameters RP computed by the interior division proportion parameter computing section 14, in a case where the convergence judging section 17 (described later) judges that the computation regarding the interior division proportion parameters RP has converged.

The initial value determining section 16 determines the initial values of the interior division proportion parameters RP referred to by the regression coefficient computing section 12. The initial value determining section 16 stores, in the storage section 15A, the initial values of the interior division proportion parameters RP determined.

The convergence judging section 17 judges whether the computation regarding the interior division proportion parameters RP has converged. The convergence judging section 17 supplies the output section 15 with the judgment result.

The predicting section 18 derives a plurality of prediction results PR by applying, to the inferencing data PD, the respective regression coefficients RC of the plurality of target models. The predicting section 18 stores the derived prediction results PR in the storage section 15A. It is therefore possible for the predicting section 18 to derive the plurality of prediction results PR with respect to the respective regression coefficients RC.

### Example Flow of Processes in Information Processing Apparatus 1A

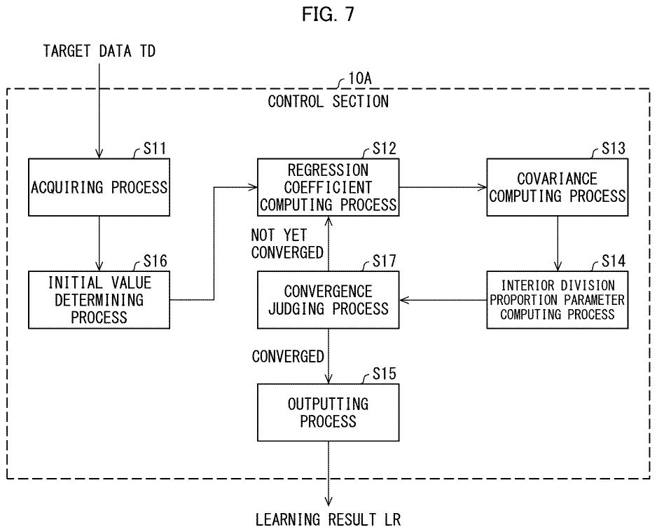

FIG. 7 is a diagram illustrating an example flow of processes in the information processing apparatus 1A in accordance with the present example embodiment. The example processes described below can be understood to be a variational Bayesian EM algorithm. However, these example processes in the present example embodiment are not limited to such an understanding. Further, the example processes described below can be understood to be the processes for updating parameters so as to maximize a variational lower bound (VLB) J which is obtained by the following Expression (11).

$$J := {\sum }_{{z}_{1 : N}} q ( {z}_{1 : N} ) log \frac{p ( {\tilde{y}}_{1 : N} , {z}_{1 : N} \vert {\tilde{x}}_{1 : N} , W , η )}{q ( {z}_{1 : N} )} \qquad ( 11 )$$

The example processes described below can be expressed as being an algorithm for solving a maximum likelihood problem which is defined by the model likelihood p in the following Expression (12).

$$p ( \tilde{y} \vert {z}_{k} , {\tilde{x}}_{k} , W , η ) = ( \tilde{y} \vert {\sum }_{i = 1}^{m} {z}_{k}^{( i )} {W}^{( i )} {\tilde{x}}_{k} , {η}^{- 1} {I}_{r} ) \qquad ( 12 )$$

### (Step S11: Acquiring Process)

In step S11, the acquiring section 11 acquires target data TD. The target data TD is used in the training process carried out in the information processing apparatus 1A, as described above. The target data TD is described in detail above, and the description thereof is therefore omitted here.

Additionally, in step S11, the acquiring section 11 further acquires a parameter m, which indicates the number of the plurality of target models. The number m of models may be expressed as being the number of interior division proportion parameter vectors μₖ⁽ⁱ⁾, as will be described later.

In addition, in step S11, the acquiring section 11 acquires information regarding a prior distribution of a latent variable zₖ. As an example, the acquiring section 11 acquires a covariance matrix (of the prior distribution p(zₖ) of the latent variable zₖ. The acquiring section 11 may further acquire a covariance parameter η of the prior distribution p(zₖ) of the latent variable zₖ.

### (Step S16: Initial Value Determining Process)

Subsequently, in step S16, the initial value determining section 16 determines the initial values of the interior division proportion parameters RP to be referred to in the regression coefficient computing process S12, which will be described later. As an example, the initial value determining section 16 determines the initial values of the interior division proportion parameters RP which are random values. In this manner, by the initial value determining section 16 determining the initial values of the interior division proportion parameters RP, it is possible to suitably calculate the regression coefficients RC in the regression coefficient computing process S12, which will be described later. The interior division proportion parameters RP are described in detail above, and the description thereof is therefore omitted here.

### (Step S12: Regression Coefficient Computing Process)

Subsequently, in step S12, the regression coefficient computing section 12 refers to the interior division proportion parameters (interior division proportion parameter vectors) RP represented by the following Expression (13)

$${\{ {μ}_{k} \}}_{k = 1}^{N} \qquad ( 13 )$$

and the target data TD represented by the following Expression (14)

$${\{ {\tilde{x}}_{k} , {\tilde{y}}_{k} \}}_{k = 1}^{N} \qquad ( 14 )$$

to compute respective regression coefficients RC of the plurality of target models, the regression coefficients RC being represented by the following Expression (15).

$$W = [ {W}^{( 1 )} , … , {W}^{( m )} ] \qquad ( 15 )$$

As an example, with reference to the interior division proportion parameters RP and the target data TD, the regression coefficient computing section 12 computes, from the following Expression (16), the regression coefficients RC represented by the following Expression (17).

$${W}^{*} = \{ {\sum }_{k = 1}^{N} {{\tilde{y}}_{k} ( {μ}_{k} ⊗ {\tilde{x}}_{k} )}^{} \} {\{ {\sum }_{k = 1}^{N} {( {Ψ}_{k} + {μ}_{k} {μ}_{k}^{⊤} ) ⊗ {\tilde{x}}_{k} {\tilde{x}}_{k}^{⊤}}^{} \}}^{- 1} \qquad ( 16 )$$

$$W = [ {W}^{( 1 )} , … , {W}^{( m )} ] \qquad ( 17 )$$

The superscript asterisk attached to W denotes a value having been updated, and in the computational expression, the symbol of operation indicated by a circle and a cross denotes the Kronecker product. T denotes transposition. Ψₖ represents the covariance parameter of a posterior distribution of the latent variable zₖ.

### (Step S13: Covariance Computing Process)

Subsequently, in step S13, the covariance computing section 13 refers to the target data TD represented by the following Expression (18),

$${\{ {\tilde{x}}_{k} , {\tilde{y}}_{k} \}}_{k = 1}^{N} \qquad ( 18 )$$

the interior division proportion parameters (interior division proportion parameter vectors) RP represented by the following Expression (19),

$${\{ {μ}_{k} \}}_{k = 1}^{N} \qquad ( 19 )$$

the regression coefficients RC represented by the following Expression (20),

$$W = [ {W}^{( 1 )} , ⋯ , {W}^{( m )} ] \qquad ( 20 )$$

and the covariance matrix Φ of the prior distribution of the latent variable zₖ, to compute a covariance parameter r of the prior distribution of the latent variable zₖ and a covariance matrix covariance matrix {Ψₖ}ₖ₌₁^{N} of a posterior distribution of the latent variable zₖ. As an example, the covariance computing section 13 uses the following Expression (21)

$${{Ψ}_{k}^{★} = ( η {Λ}_{k}^{⊤} {Λ}_{k} + {Φ}^{- 1} \}}^{- 1} \qquad ( 21 )$$

(where Λₖ is given by the following Expression (22))

$${Λ}_{k} := [ {W}^{( 1 )} {\tilde{x}}_{k} , … , {W}^{( m )} {\tilde{x}}_{k} ] \qquad ( 22 )$$

to compute the covariance matrix {Ψₖ}ₖ₌₁^{N} of the posterior distribution of the latent variable zₖ. Further, the covariance computing section 13 uses the following Expression (23)

$${η}^{★} = \frac{Nr}{{𝔼}_{q} [ {\sum }_{k = 1}^{N} {‖ {\tilde{y}}_{k} - W ( {𝓏}_{k} ⊗ {\tilde{x}}_{k} ) ‖}^{2} ]} \qquad ( 23 )$$

to compute the covariance parameter η of the prior distribution of the latent variable zₖ. N is the number of samples of each state variable, as described above, and r is the dimension of ˜yₖ, and is r=1, for example.

### (Step S14: Interior Division Proportion Parameter Computing Process)

Subsequently, in step S14, the interior division proportion parameter computing section 14 refers to the target data TD represented by the following Expression (24),

$${\{ {\tilde{x}}_{k} , {\tilde{y}}_{k} \}}_{k = 1}^{N} \qquad ( 24 )$$

the regression coefficients RC represented by the following Expression (25),

$$W = [ {W}^{( 1 )} , ⋯ , {W}^{( m )} ] \qquad ( 25 )$$

and the covariance matrix {Ψₖ}ₖ₌₁^{N} of the posterior distribution of the latent variable zₖ, to compute (update) the interior division proportion parameters (interior division proportion parameter vectors) RP represented by the following Expression (26).

$${\{ {μ}_{k} \}}_{k = 1}^{N} \qquad ( 26 )$$

As an example, the interior division proportion parameter computing section 14 uses the following Expression (27)

$${μ}_{k}^{★} = {arg min}_{{μ}_{k}} \{ \frac{1}{2} {{μ}_{k}^{⊤} ( {Ψ}_{k}^{★} )}^{- 1} {μ}_{k} - ( η {\tilde{y}}_{k}^{⊤} {Λ}_{k} + \frac{1}{m} {1}_{m , 1} {Φ}^{- 1} ) {μ}_{k} \} \qquad ( 27 )$$

to carry out the process of calculating μₖ under a constraint condition (limiting condition) regarding a summation of the interior division proportion parameters RP, and thereby computes (updates) the interior division proportion parameters RP. As an example, the interior division proportion parameter computing section 14 uses the following Expression (28)

$${μ}_{k}^{★} = {arg min}_{{μ}_{k}} \{ \frac{1}{2} {{μ}_{k}^{⊤} ( {Ψ}_{k}^{★} )}^{- 1} {μ}_{k} - ( η {\tilde{y}}_{k}^{⊤} {Λ}_{k} + \frac{1}{m} {1}_{m , 1} {Φ}^{- 1} ) {μ}_{k} \} \qquad ( 28 )$$

to carry out the process of calculating μₖ under the constraint condition (limiting condition) represented by the following Expression (29), to compute the interior division proportion parameters (interior division proportion parameter vectors) RP represented by the following Expression (30).

$${1}_{m , 1}^{⊤} {μ}_{k} = 1 , {μ}_{k} ⪰ {0}_{m , 1} \qquad ( 29 )$$

$${\{ {μ}_{k} \}}_{k = 1}^{N} \qquad ( 30 )$$

If expressed by explicitly indicating the index (i) regarding the models, the first expression of the above constraint condition can be expressed as follows.

$${\sum }_{i = 1}^{m} {μ}_{k}^{( i )} = 1$$

In other words, the first expression of the above constraint condition indicates that the summation of the interior division proportion parameters RP performed over a range of the indices regarding the models is 1. Further, the second expression of the constraint condition indicates that the values of the interior division proportion parameters RP are not less than 0. In this manner, by the interior division proportion parameter computing section 14 computing the interior division proportion parameters RP under the constraint condition, it is possible to suitably calculate the interior division proportion parameters RP even in a case of, for example, adopting a normal distribution as the posterior distribution of the latent variable.

### (Step S17: Convergence Judging Process)

Subsequently, in step S17, the convergence judging section 17 judges whether the above described series of processes carried out by the steps S12, S13, and S14 has converged. This may be expressed as judging whether the above variational Bayesian EM algorithm has converged, or may be expressed as judging whether the computation of the interior division proportion parameters RP in step S14 has converged. As an example, the convergence judging section 17 refers to the variational lower bound (VLB) J obtained by the following Expression (31),

$$J := {\sum }_{{𝓏}_{1 : N}} q ( {𝓏}_{1 : N} ) log \frac{p ( {\tilde{y}}_{1 : N} , {𝓏}_{1 : N} \vert {\tilde{x}}_{1 : N} , W , η )}{q ( {𝓏}_{1 : N} )} \qquad ( 31 )$$

and in a case where the amount of change in the variational lower bound is equal to or smaller than a predetermined threshold, judges that the series of processes carried out by the steps S12, S13, and S14 has converged. For example, in the n-th convergence judging process in iterations of the series of processes carried out by the steps S12, S13, and S14, the convergence judging section 17 compares the variational lower bound for the (n−1)-th convergence judging process with the variational lower bound for the n-th convergence judging process, and in a case where the absolute value of the difference of these variational lower bounds is equal to or smaller than the predetermined threshold, judges that the series of processes carried out by steps S12, S13, and S14 has converged.

In a case where the convergence judging section 17 judges that the series of processes “has converged”, the processing proceeds to the outputting process S15, and in a case where the convergence judging section 17 judges that the series of processes “has not converged”, the processing returns to the regression coefficient computing process S12 so that the computation of the regression coefficients RC is repeated.

### (Step S15: Outputting Process)

In a case where in step S17, the convergence judging section 17 judges that the series of processes “has converged”, the output section 15 outputs, in step S15, the regression coefficients RC computed by the regression coefficient computing section 12 in step S12 and the interior division proportion parameters RP (learning result LR) computed by the interior division proportion parameter computing section 14 in step S14. In this manner, by outputting the learning result LR in a case where the convergence judging section 17 judges that the computation regarding the interior division proportion parameters RP “has converged”, it is possible for the output section 15 to output a suitable learning result LR.

Further, in step S15, the output section 15 may be configured to further output the covariance parameter η of the prior distribution of the latent variable zₖ and the covariance matrix T of the posterior distribution of the latent variable zₖ, which are computed by the covariance computing section 13 in step S13. With such a configuration, it is possible for the output section 15 to present, to a user, the covariance parameter η of the prior distribution of the latent variable zₖ and the covariance matrix T of the posterior distribution of the latent variable zₖ.

Further, in step S15, the output section 15 may be configured to display graphs defined by the regression coefficients RC of at least two target models of the plurality of target models, such that the graphs are discriminable from each other.

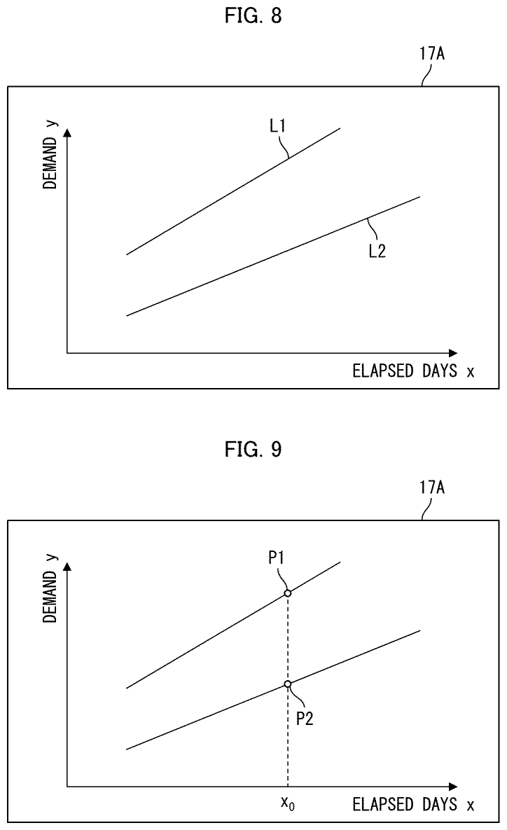

FIG. 8 is an example of graphs displayed by the output section 15 via the input-output section 17A in this step. In the example illustrated in FIG. 8, in the regression coefficient computing process of step S12, among the following regression coefficients RC which are computed for the plurality of respective target models and which are represented by the following Expression (32),

$$W = [ {W}^{( 1 )} , ⋯ , {W}^{( m )} ] \qquad ( 32 )$$

the output section 15 displays a graph L1 defined by the regression coefficient W⁽¹⁾ of the model 1 and a graph L2 defined by the regression coefficient W⁽²⁾ of the model 2, such that the graphs L1 and L2 are discriminable from each other. In this manner, with the information processing apparatus 1A in accordance with the present example embodiment, it is possible to not only use a plurality of models but also determine the interior division proportion parameters RP of the respective models by learning. This makes it possible to generate an output result having latitude (e.g., the output result having the latitude defined by the graph L1 and the graph L2)

### Example Process Carried Out by Predicting Section 18

The predicting section 18 derives a plurality of prediction results PR by applying, to the inferencing data PD, the respective regression coefficients RC of the plurality of target models. As an example, in a case where the inferencing data PD is an inner state quantity x₀ in the 0-th step, the predicting section 18 derives the plurality of prediction results PR by applying, to the inner state quantity x₀, the respective regression coefficients RC of the plurality of target models.

For example, the predicting section 18 derives a prediction result P1 by applying the regression coefficient W⁽¹⁾ of the model 1, and derives a prediction result P2 by applying the regression coefficient W⁽²⁾ of the model 2. Illustrated in FIG. 9 is an example of graphs displayed by the output section 15 via the input-output section 17A. FIG. 9 is another example of graphs displayed by the output section 15 via the input-output section 17A.

In the example illustrated in FIG. 9, the output section 15 displays the prediction result P1 and the prediction result P2 such that these prediction results are discriminable from each other, the prediction result P1 and the prediction result P2 being derived by the predicting section 18 applying, to the inner state quantity x₀ as the inferencing data PD, the regression coefficient W⁽¹⁾ of the model 1 and the regression coefficient W⁽²⁾ of the model 2, respectively. In this manner, with the information processing apparatus 1A in accordance with the present example embodiment, it is possible to generate, with respect to the inferencing data PD, a prediction result PR having latitude.

Assume, for example, models for predicting sales of drinking water in a store. Assume, as an example, that the target data TD used in training the model 1 indicates sales for the case of implementing a measure and the target data TD used in training the model 2 indicates sales for the case of changing the volume of substance.

In this case, for example, by applying the regression coefficient W⁽¹⁾ of the model 1 to a time x₀, the predicting section 18 derives the prediction result P1 with respect to the sales for the case of implementing a measure at the time x₀. Further, by applying the regression coefficient W⁽²⁾ of the model 2 to the time x₀, the predicting section 18 derives the prediction result P2 with respect to the sales for the case of changing the volume of substance at the time x₀.

### Example Advantage of Information Processing Apparatus 1A

As above, in the information processing apparatus 1A, with reference to the target data TD and the interior division proportion parameters RP which define the interior division proportions of a plurality of target models, respective regression coefficients RC of the plurality of target models are computed. Further, in the information processing apparatus 1A, with reference to the target data TD, the interior division proportion parameters RP, the regression coefficients RC, and information regarding a prior distribution of a latent variable zₖ, a covariance parameter of the prior distribution of the latent variable zₖ and a covariance matrix of a posterior distribution of the latent variable zₖ are computed. Further, in the information processing apparatus 1A, with reference to the target data TD, the regression coefficients RC, and the covariance matrix of the posterior distribution of the latent variable zₖ, the interior division proportion parameters RP are computed. In addition, in the information processing apparatus 1A, the regression coefficients RC and the computed interior division proportion parameters RP are outputted.

With this configuration, by treating the interior division proportion parameters RP as (the posterior probability of) the latent variable zₖ and applying a latent variable model training method used in machine learning, it is possible for the information processing apparatus 1A to assign highly accurate interior division proportion parameters RP even if the interior division proportion parameters RP are unknown.

### Third Example Embodiment

The following description will discuss, in detail, a third example embodiment which is an example embodiment of the present invention, with reference to the drawings. A component having the same function as a component described in the above example embodiment is assigned the same reference sign, and the description thereof is omitted where appropriate. It should be noted that the applicability of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle.

### (Configuration of Information Processing Apparatus 2A)

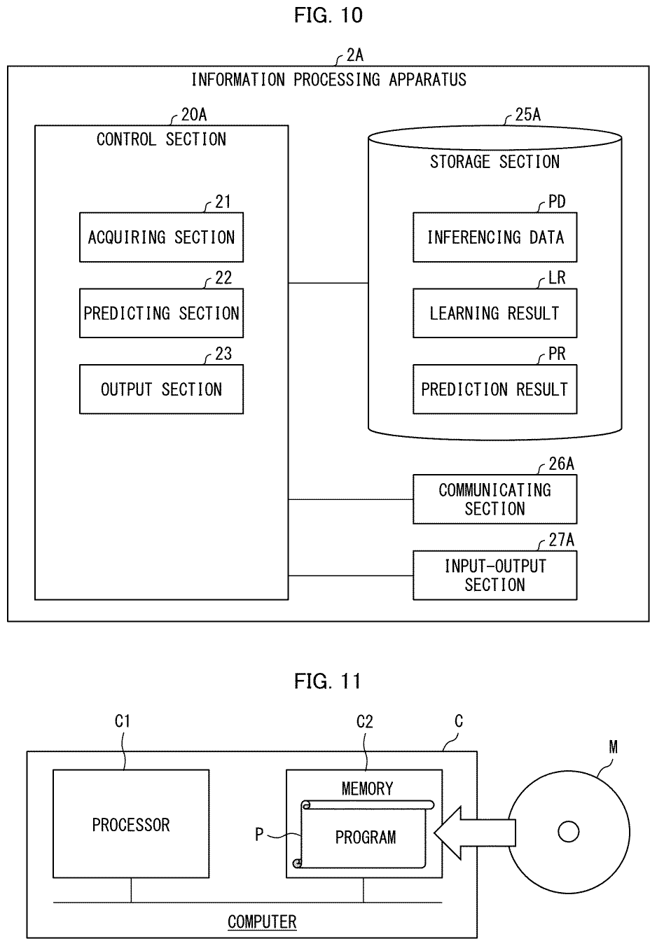

The configuration of the information processing apparatus 2A is described here with reference to FIG. 10. FIG. 10 is a block diagram illustrating the configuration of the information processing apparatus 2A. The information processing apparatus 2A includes a control section 20A, a storage section 25A, a communicating section 26A, and an input-output section 27A, as illustrated in FIG. 10.

As in the storage section 15A above, data referred to by the control section 20A is stored in the storage section 25A. Examples of the data stored in the storage section 25A include, but are not limited to, inferencing data PD, a learning result LR, and a prediction result PR, as illustrated in FIG. 10. The inferencing data PD, the learning result LR, and the prediction result PR are as described above.

Like the communicating section 16A, the communicating section 26A is an interface through which data is transmitted and received via a network.

Like the input-output section 17A, the input-output section 27A is an interface through which data input is accepted and data is outputted.

### (Control Section 20A)

The control section 20A controls the components of the information processing apparatus 2A. Further, the control section 20A includes an acquiring section 21, a predicting section 22, and an output section 23, as illustrated in FIG. 10.

The acquiring section 21 acquires inferencing data PD. The acquiring section 21 stores the acquired inferencing data PD in the storage section 25A.

The predicting section 22 derives a plurality of prediction results PR by applying, to the inferencing data PD, respective regression coefficients of a plurality of target models. The regression coefficients used by the predicting section 22 are included in a learning result LR. The predicting section 22 stores the plurality of derived prediction results PR in the storage section 25A.

The respective regression coefficients of a plurality of target models applied by the predicting section 22 are trained by a training process which includes: a regression coefficient computing process of computing respective regression coefficients of a plurality of target models with reference to training data and interior division proportion parameters that define the interior division proportions of the plurality of target models; a covariance computing process of computing a covariance parameter of a prior distribution of a latent variable and a covariance matrix of a posterior distribution of the latent variable with reference to the training data, the interior division proportion parameters, the regression coefficients computed by the regression coefficient computing process, and information regarding the prior distribution of the latent variable; and an interior division proportion parameter computing process of computing the interior division proportion parameters with reference to the training data, the regression coefficients computed by the regression coefficient computing process, and the covariance matrix of the posterior distribution of the latent variable. Examples of the training data include the target data TD described above.

The output section 23 outputs a prediction result PR derived by the predicting section 22. Examples of the prediction result PR outputted by the output section 23 are as described with reference to FIG. 9. That is, the output section 23 displays graphs which indicate at least two prediction results PR of the plurality of prediction results PR and which are defined by the regression coefficients, such that the graphs are discriminable from each other. This makes it possible for the output section 23 to generate, with respect to the inferencing data PD, a prediction result PR having latitude (e.g., a prediction result having the latitude defined by the prediction result P1 and the prediction result P2 illustrated in FIG. 9).

### (Configuration of Information Processing Apparatus 2A)

As above, in the information processing apparatus 2A, a plurality of prediction results PR are derived by applying, to inferencing data PD, respective regression coefficients of a plurality of target models, the regression coefficients being trained by a training process.

With this configuration, by treating the interior division proportion parameters as (the posterior probability of) the latent variable and applying a latent variable model training method used in machine learning, it is possible for the information processing apparatus 2A to assign highly accurate interior division proportion parameters even if the interior division proportion parameters are unknown.

Since the prediction results PR are derived by applying, to the inferencing data PD, the regression coefficients that are of the plurality of respective target models and that are computed with use of highly accurate interior division proportion parameters, it is possible to derive a prediction result PR having latitude.

### Software Implementation Example

Some or all of the functions of each of the information processing apparatuses 1, 1A, 2, and 2A (hereinafter also referred to as “each apparatus above”) may be implemented by hardware such as an integrated circuit (IC chip), or may be implemented by software.

In the latter case, each apparatus above is provided by, for example, a computer that executes instructions of a program that is software implementing the functions. An example (hereinafter, computer C) of such a computer is illustrated in FIG. 11. FIG. 11 is a block diagram illustrating a hardware configuration of the computer C which functions as each apparatus above.

The computer C includes at least one processor C1 and at least one memory C2. The memory C2 has recorded thereon a program P for causing the computer C to operate as each apparatus above. The processor C1 of the computer C retrieves the program P from the memory C2 and executes the program P, so that the functions of each apparatus above are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display, or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can obtain the program P also via such a transmission medium.

### [Additional Remark A]

The whole or part of the example embodiments disclosed above can be described as, but not limited to, the following supplementary notes. Note, however, that the present invention is not limited to the techniques described in the supplementary notes below, but may be altered in various ways by a skilled person within the scope of the claims.

### (Supplementary Note A1)

An information processing apparatus, including
an acquiring means for acquiring target data, the number of a plurality of target models, and information regarding a prior distribution of a latent variable;
a regression coefficient computing means for computing respective regression coefficients of the plurality of target models with reference to the target data and interior division proportion parameters which define interior division proportions of the plurality of target models;
a covariance computing means for computing a covariance parameter of the prior distribution of the latent variable and a covariance matrix of a posterior distribution of the latent variable with reference to the target data, the interior division proportion parameters, the respective regression coefficients, and the information regarding the prior distribution of the latent variable;
an interior division proportion parameter computing means for computing the interior division proportion parameters with reference to the target data, the respective regression coefficients, and the covariance matrix of the posterior distribution of the latent variable; and
an output means for outputting the respective regression coefficients and the interior division proportion parameters computed by the interior division proportion parameter computing means.

### (Supplementary Note A2)

The information processing apparatus described in supplementary note A1, in which the interior division proportion parameter computing means is configured to compute the interior division proportion parameters under a limiting condition regarding a summation of the interior division proportion parameters.

### (Supplementary Note A3)

The information processing apparatus described in supplementary note A1 or A2, further including an initial value determining means for determining initial values of the interior division proportion parameters referred to by the regression coefficient computing means.

### (Supplementary Note A4)

The information processing apparatus described in any one of supplementary notes A1 to A3, further including a convergence judging means for judging whether a computation of the interior division proportion parameters has converged,
in a case where the convergence judging means judges that the computation has converged, the output means being configured to output the respective regression coefficients and the interior division proportion parameters.

### (Supplementary Note A5)

The information processing apparatus described in any one of supplementary notes A1 to A4, in which
the output means is configured to display graphs which are defined by the respective regression coefficients of at least two target models of the plurality of target models, such that the graphs are discriminable from each other.

### (Supplementary Note A6)

The information processing apparatus described in any one of supplementary notes A1 to A5, in which
the output means is configured to further output the covariance parameter of the prior distribution of the latent variable and the covariance matrix of the posterior distribution of the latent variable, which are computed by the covariance computing means.

### (Supplementary Note A7)

The information processing apparatus described in any one of supplementary notes A1 to A6, in which
the acquiring means is configured to further acquire inferencing data, and
the information processing apparatus further includes
a predicting means for deriving a plurality of prediction results by applying, to the inferencing data, the respective regression coefficients of the plurality of target models.

### (Supplementary Note A8)

The information processing apparatus described in any one of supplementary notes A1 to A7, in which
the interior division proportion parameters correspond to an expectation of the latent variable.

### (Supplementary Note A9)

An information processing apparatus, including: an acquiring means for acquiring inferencing data;
a predicting means for deriving a plurality of prediction results by applying, to the inferencing data, respective regression coefficients of a plurality of target models; and
an output means for outputting the plurality of prediction results derived by the predicting means,
the respective regression coefficients of the plurality of target models being trained by a training process which includes:
   a regression coefficient computing process of computing the respective regression coefficients of the plurality of target models with reference to training data and interior division proportion parameters which define interior division proportions of the plurality of target models;
   a covariance computing process of computing a covariance parameter of a prior distribution of a latent variable and a covariance matrix of a posterior distribution of the latent variable, with reference to the training data, the interior division proportion parameters, the respective regression coefficients computed by the regression coefficient computing process, and information regarding the prior distribution of the latent variable; and
   an interior division proportion parameter computing process of computing the interior division proportion parameters with reference to the training data, the respective regression coefficients computed by the regression coefficient computing process, and the covariance matrix of the posterior distribution of the latent variable.

### (Supplementary Note A10)

The information processing apparatus described in supplementary note A9, in which
the output means is configured to display graphs which represent at least two of the plurality of prediction results and which are defined by the respective regression coefficients, such that the graphs are discriminable from each other.

### (Supplementary Note A11)

A program for causing a computer to function as the information processing apparatus described in any one of supplementary notes A1 to A10, the program causing the computer to function as the acquiring means, the regression coefficient computing means, the covariance computing means, the interior division proportion parameter computing means, and the output means.

### (Supplementary Note A12)

A program for causing a computer to function as the information processing apparatus described in supplementary note A9 or A10, the program causing the computer to function as the acquiring means, the predicting means, and the output means.

### (Supplementary Note A13)

A non-transitory recording medium having recorded thereon a program for causing a computer to function as the information processing apparatus described in any one of supplementary notes A1 to A10, the program causing the computer to function as the acquiring means, the regression coefficient computing means, the covariance computing means, the interior division proportion parameter computing means, and the output means.

### (Supplementary Note A14)

A non-transitory recording medium having recorded thereon a program for causing a computer to function as the information processing apparatus described in supplementary note A9 or A10, the program causing the computer to function as the acquiring means, the predicting means, and the output means.

### [Additional Remark B]

The whole or part of the example embodiments disclosed above can be described as, but not limited to, the following supplementary notes. Note, however, that the present invention is not limited to the techniques described in the supplementary notes below, but may be altered in various ways by a skilled person within the scope of the claims.

### (Supplementary Note B1)

An information processing method, including
at least one processor acquiring target data, the number of a plurality of target models, and information regarding a prior distribution of a latent variable;
the at least one processor computing respective regression coefficients of the plurality of target models with reference to the target data and interior division proportion parameters which define interior division proportions of the plurality of target models;
the at least one processor computing a covariance parameter of the prior distribution of the latent variable and a covariance matrix of a posterior distribution of the latent variable with reference to the target data, the interior division proportion parameters, the respective regression coefficients, and the information regarding the prior distribution of the latent variable;
the at least one processor computing the interior division proportion parameters with reference to the target data, the respective regression coefficients, and the covariance matrix of the posterior distribution of the latent variable; and
the at least one processor outputting the respective regression coefficients and the interior division proportion parameters computed by the computing of the interior division proportion parameters.

### (Supplementary Note B2)

The information processing method described in supplementary note B1, in which
in the computing of the interior division proportion parameters, the at least one processor computes the interior division proportion parameters under a limiting condition regarding a summation of the interior division proportion parameters.

### (Supplementary Note B3)

The information processing method described in supplementary note B1 or B2, further including the at least one processor determining initial values of the interior division proportion parameters referred to in the computing of the respective regression coefficients.

### (Supplementary Note B4)

The information processing method described in any one of supplementary notes B1 to B3, further including the at least one processor judging whether a computation of the interior division proportion parameters has converged,
in the outputting, in a case where the computation is judged, in the judging, to have converged, the output means being configured to output the respective regression coefficients and the interior division proportion parameters.

### (Supplementary Note B5)

The information processing method described in any one of supplementary notes B1 to B4, in which
in the outputting, the at least one processor displays graphs which are defined by the respective regression coefficients of at least two target models of the plurality of target models, such that the graphs are discriminable from each other.

### (Supplementary Note B6)

The information processing method described in any one of supplementary notes B1 to B5, in which
in the outputting, the at least one processor further outputs the covariance parameter of the prior distribution of the latent variable and the covariance matrix of the posterior distribution of the latent variable, which are computed by the computing of the covariance parameter and the covariance matrix.

### (Supplementary Note B7)

The information processing method described in any one of supplementary notes B1 to B6, in which
in the acquiring, the at least one processor further acquires inferencing data, and
the information processing method further includes the at least one processor deriving a plurality of prediction results by applying, to the inferencing data, the respective regression coefficients of the plurality of target models.

### (Supplementary Note B8)

The information processing method described in any one of supplementary notes B1 to B7, in which
the interior division proportion parameters correspond to an expectation of the latent variable.

### (Supplementary Note B9)

An information processing method, including:
at least one processor acquiring inferencing data;
the at least one processor deriving a plurality of prediction results by applying, to the inferencing data, respective regression coefficients of a plurality of target models; and
the at least one processor outputting the plurality of prediction results derived by the deriving,
the respective regression coefficients of the plurality of target models being trained by a training process which includes:
   a regression coefficient computing process of computing the respective regression coefficients of the plurality of target models with reference to training data and interior division proportion parameters which define interior division proportions of the plurality of target models;
   a covariance computing process of computing a covariance parameter of a prior distribution of a latent variable and a covariance matrix of a posterior distribution of the latent variable, with reference to the training data, the interior division proportion parameters, the respective regression coefficients computed by the regression coefficient computing process, and information regarding the prior distribution of the latent variable; and
   an interior division proportion parameter computing process of computing the interior division proportion parameters with reference to the training data, the respective regression coefficients computed by the regression coefficient computing process, and the covariance matrix of the posterior distribution of the latent variable.

### (Supplementary Note B10)

The information processing method described in supplementary note B9, in which
in the outputting, the at least one processor displays graphs which represent at least two of the plurality of prediction results and which are defined by the respective regression coefficients, such that the graphs are discriminable from each other.

### [Additional Remark C]

The whole or part of the example embodiments disclosed above can be described as, but not limited to, the following supplementary notes. Note, however, that the present invention is not limited to the techniques described in the supplementary notes below, but may be altered in various ways by a skilled person within the scope of the claims.

### (Supplementary Note C1)

An information processing apparatus, including
at least one processor, the at least one processor carrying out:
an acquiring process of acquiring target data, the number of a plurality of target models, and information regarding a prior distribution of a latent variable;
a regression coefficient computing process of computing respective regression coefficients of the plurality of target models with reference to the target data and interior division proportion parameters which define interior division proportions of the plurality of target models;
a covariance computing process of computing a covariance parameter of the prior distribution of the latent variable and a covariance matrix of a posterior distribution of the latent variable, with reference to the target data, the interior division proportion parameters, the respective regression coefficients, and the information regarding the prior distribution of the latent variable;
an interior division proportion parameter computing process of computing the interior division proportion parameters with reference to the target data, the respective regression coefficients, and the covariance matrix of the posterior distribution of the latent variable; and
an outputting process of outputting the respective regression coefficients and the interior division proportion parameters computed by the interior division proportion parameter computing process.

The information processing apparatus may further include a memory. The memory may have stored therein a program for causing the at least one processor to carry out each of the processes.

### (Supplementary Note C2)

The information processing apparatus described in supplementary note C1, in which
in the interior division proportion parameter computing process, the at least one processor computes the interior division proportion parameters under a limiting condition regarding a summation of the interior division proportion parameters.

### (Supplementary Note C3)

The information processing apparatus described in supplementary note C1 or C2, in which
at least one processor
further carries out an initial value determining process of determining initial values of the interior division proportion parameters referred to in the regression coefficient computing process.

### (Supplementary Note C4)

The information processing apparatus described in any one of supplementary notes C1 to C3, in which
the at least one processor further carries out a convergence judging process of judging whether a computation of the interior division proportion parameters has converged, and
in the outputting process, in a case where in the convergence judging process, the computation is judged to have converged, the at least one processor outputs the respective regression coefficients and the interior division proportion parameters.

### (Supplementary Note C5)

The information processing apparatus described in any one of supplementary notes C1 to C4, in which
in the outputting process, the at least one processor displays graphs which are defined by the respective regression coefficients of at least two target models of the plurality of target models, such that the graphs are discriminable from each other.

### (Supplementary Note C6)

The information processing apparatus described in any one of supplementary notes C1 to C5, in which
in the outputting process, the at least one processor further outputs the covariance parameter of the prior distribution of the latent variable and the covariance matrix of the posterior distribution of the latent variable, which are computed by the covariance computing process.

### (Supplementary Note C7)

The information processing apparatus described in any one of supplementary notes C1 to C6, in which
in the acquiring process, the at least one processor further acquires inferencing data, and
further carries out a predicting process of deriving a plurality of prediction results by applying, to the inferencing data, the respective regression coefficients of the plurality of target models.

### (Supplementary Note C8)

The information processing apparatus described in any one of supplementary notes C1 to C7, in which
the interior division proportion parameters correspond to an expectation of the latent variable.

### (Supplementary Note C9)

An information processing apparatus, including
at least one processor, the at least one processor carrying out:
an acquiring process of acquiring inferencing data;
a predicting process of deriving a plurality of prediction results by applying, to the inferencing data, respective regression coefficients of a plurality of target models; and
an outputting process of outputting the plurality of prediction results derived by the predicting process,
the respective regression coefficients of the plurality of target models being trained by a training process which includes:
   a regression coefficient computing process of computing the respective regression coefficients of the plurality of target models with reference to training data and interior division proportion parameters which define interior division proportions of the plurality of target models;
   a covariance computing process of computing a covariance parameter of a prior distribution of a latent variable and a covariance matrix of a posterior distribution of the latent variable, with reference to the training data, the interior division proportion parameters, the respective regression coefficients computed by the regression coefficient computing process, and information regarding the prior distribution of the latent variable; and
   an interior division proportion parameter computing process of computing the interior division proportion parameters with reference to the training data, the respective regression coefficients computed by the regression coefficient computing process, and the covariance matrix of the posterior distribution of the latent variable.

### (Supplementary Note C10)

The information processing apparatus described in supplementary note C9, in which
in the outputting process, the at least one processor displays graphs which represent at least two of the plurality of prediction results and which are defined by the respective regression coefficients, such that the graphs are discriminable from each other.

### REFERENCE SIGNS LIST

1, 1A, 2, 2A: Information processing apparatus
11, 21: Acquiring section
12: Regression coefficient computing section
13: Covariance computing section
14: Interior division proportion parameter computing section
15, 23: Output section
16: Initial value determining section
17: Convergence judging section
18, 22: Predicting section
TD: Target data
RP: Interior division proportion parameter
RC: Regression coefficient
DI: Distribution information
LR: Learning result
PD: Inferencing data
PR: Prediction result

1. An information processing apparatus, comprising
at least one processor, the at least one processor carrying out:
an acquiring process of acquiring target data, the number of a plurality of target models, and information regarding a prior distribution of a latent variable;
a regression coefficient computing process of computing respective regression coefficients of the plurality of target models with reference to the target data and interior division proportion parameters which define interior division proportions of the plurality of target models;
a covariance computing process of computing a covariance parameter of the prior distribution of the latent variable and a covariance matrix of a posterior distribution of the latent variable, with reference to the target data, the interior division proportion parameters, the respective regression coefficients, and the information regarding the prior distribution of the latent variable;
an interior division proportion parameter computing process of computing the interior division proportion parameters with reference to the target data, the respective regression coefficients, and the covariance matrix of the posterior distribution of the latent variable; and
an outputting process of outputting the respective regression coefficients and the interior division proportion parameters computed in the interior division proportion parameter computing process.

2. The information processing apparatus according to claim 1, wherein in the interior division proportion parameter computing process, the at least one processor computes the interior division proportion parameters under a limiting condition regarding a summation of the interior division proportion parameters.

3. The information processing apparatus according to claim 1, wherein the at least one processor
further carries out a convergence judging process of judging whether a computation of the interior division proportion parameters has converged, and
in the outputting process, in a case where in the convergence judging process, the computation is judged to have converged, the at least one processor outputs the respective regression coefficients and the interior division proportion parameters.

4. The information processing apparatus according to claim 1, wherein in the outputting process, the at least one processor displays graphs which are defined by the respective regression coefficients of at least two target models of the plurality of target models, such that the graphs are discriminable from each other.

5. The information processing apparatus according to claim 1, wherein in the acquiring process, the at least one processor further acquires inferencing data, and
the at least one processor further carries out
a predicting process of deriving a plurality of prediction results by applying, to the inferencing data, the respective regression coefficients of the plurality of target models.

6. The information processing apparatus according to claim 1, wherein the interior division proportion parameters correspond to an expectation of the latent variable.

7. An information processing apparatus, comprising
at least one processor, the at least one processor carrying out:
an acquiring process of acquiring inferencing data;
a predicting process of deriving a plurality of prediction results by applying, to the inferencing data, respective regression coefficients of a plurality of target models; and
an outputting process of outputting the plurality of prediction results derived by the predicting process,
the respective regression coefficients of the plurality of target models being trained by a training process which includes:
a regression coefficient computing process of computing the respective regression coefficients of the plurality of target models with reference to training data and interior division proportion parameters which define interior division proportions of the plurality of target models;
a covariance computing process of computing a covariance parameter of a prior distribution of a latent variable and a covariance matrix of a posterior distribution of the latent variable, with reference to the training data, the interior division proportion parameters, the respective regression coefficients computed by the regression coefficient computing process, and information regarding the prior distribution of the latent variable; and
an interior division proportion parameter computing process of computing the interior division proportion parameters with reference to the training data, the respective regression coefficients computed by the regression coefficient computing process, and the covariance matrix of the posterior distribution of the latent variable.

8. The information processing apparatus according to claim 7, wherein in the outputting process, the at least one processor displays graphs which represent at least two of the plurality of prediction results and which are defined by the respective regression coefficients, such that the graphs are discriminable from each other.

9. An information processing method, comprising:
at least one processor acquiring target data, the number of a plurality of target models, and information regarding a prior distribution of a latent variable;
the at least one processor computing respective regression coefficients of the plurality of target models with reference to the target data and interior division proportion parameters which define interior division proportions of the plurality of target models;
the at least one processor computing a covariance parameter of the prior distribution of the latent variable and a covariance matrix of a posterior distribution of the latent variable with reference to the target data, the interior division proportion parameters, the respective regression coefficients, and the information regarding the prior distribution of the latent variable;
the at least one processor computing the interior division proportion parameters with reference to the target data, the respective regression coefficients, and the covariance matrix of the posterior distribution of the latent variable; and
the at least one processor outputting the respective regression coefficients and the interior division proportion parameters computed by the computing of the interior division proportion parameters.

10. A non-transitory recording medium storing a program for causing a computer to function as the information processing apparatus according to claim 1, the program being for carrying out the acquiring process, the regression coefficient computing process, the covariance computing process, the interior division proportion parameter computing process, and the outputting process.
